(19) United States
(12) Patent Application Publication
(10) Pub. No.: US 2017/0269893 A1
(43) Pub. Date: Sep. 21, 2017

(54) REMOTE RENDERING OF LOCALLY DISPLAYED CONTENT

(71) Applicant: Google Inc., Mountain View, CA (US)

(72) Inventors: Fady SAMUEL, Kitchener (CA); Robert John Kroeger, San Francisco, CA (US); Ian Edward Vollick, Waterloo (CA)

(21) Appl. No.: 15/072,332

(22) Filed: Mar. 16, 2016

(51) Int. Cl. G06F 3/14; G06F 3/0481

(52) U.S. Cl. CPC G06F 3/14; G06F 3/0481

(57) ABSTRACT

Methods for remote rendering of locally displayed content are provided. In one aspect, a method includes receiving a request on a device by an application to load a document that includes content for display by the application on the device and rendering by the device at least a first portion of the content for display. The method also includes sending a request to a remote device to render at least a second portion of the content for display, and receiving from the remote device the rendered second portion of the content. The method further includes compositing the rendered first portion of the content and the rendered second portion of the content for display by the application on the device. Systems and machine-readable media are also provided.

### BACKGROUND

A user may view a document, such as a web page, on a computing system (e.g., a smart phone, laptop, etc.). The web page may include text, images, video content (e.g., embedded video) and/or other forms of web content. Visual content on the web page, and more particularly layers of the visual scene of the web page, are commonly rendered for display and then composited together using a compositor, which is software responsible for combining visual elements from separate sources into a single image creating an illusion that the elements are parts of a same scene. The display of visual content for which rendering is resource intensive can cause delays on computing systems with limited available resources, such as mobile computing devices.

### SUMMARY

The disclosed system provides for dividing responsibility for rendering portions (e.g., visual layers) of a document, such as a web page, to be displayed on a local device by having certain portions of the document rendered remotely by a remote computing device while other portions of the web page are rendered locally by the local device. The different portions are then combined and displayed to the user using a compositor of the application displaying the document. The rendering of different portions of the document can be assigned to different processes of the application. The portions that are rendered remotely can be lower priority content from the document, such as advertisements in the document.

According to some implementations of the present disclosure, a computer-implemented method is provided. The method includes receiving a request on a device by an application to load a document that includes content for display by the application on the device, and rendering by the device at least a first portion of the content for display. The method also includes sending a request to a remote device to render at least a second portion of the content for display, and receiving from the remote device the rendered second portion of the content. The method further includes compositing the rendered first portion of the content and the rendered second portion of the content for display by the application on the device.

In certain aspects, the method includes assigning rendering of the first portion of the content to a first process of the application, and rendering of the second portion of the content to a second process of the application, wherein the sending the request and the receiving the rendered second portion of the content is conducted by the second process. In certain aspects of the method, the request sent to the remote device includes information regarding the device that is usable by the remote device to determine at least an output format of the rendered second portion of the content. In certain aspects, the information regarding the device includes information identifying resources available to the device, software operating on the device, and a requested output format for the rendered second portion of the content. In certain aspects of the method, the first portion of the content is provided by a first website, and the second portion of the content is provided by a second website. In certain aspects, the document includes a webpage, the application includes a web browser, and the second portion of the content is provided in at least one iframes within the webpage. In certain aspects, the second portion of the content includes an advertisement, and the decision to send the request to the remote device is made because at least one of the device will take longer to render the advertisement than the remote device will take to render and provide the rendered advertisement to the device, the advertisement is not interactive, or the device is determined to have insufficient resources to commit to rendering of the advertisement. In certain aspects of the method, the second portion of the content includes a plurality of advertisements, the document includes a webpage, the application includes a web browser, and each of the plurality of advertisements is displayed in a respective iframe of the webpage, and the method further includes assigning rendering of the first portion of the content to a first process of the application, and rendering of each of the plurality of the advertisements to additional processes of the application, wherein the sending the request and the receiving the rendered second portion of the content is conducted for each of the plurality of the advertisements by their respective additional processes.

According to some implementations of the present disclosure, a computer-implemented method is provided. The method includes receiving a request at a server from an application on a device requesting rendering of a second portion of content of a document for display, the document that includes a first portion of content and the second portion of content, and the request that includes information identifying resources available to the device, software operating on the device, and a requested output format for the rendered second portion of the content. The method also includes rendering by the server in the requested output format the second portion of the content for display based on the resources available to the device and software operating on the device, and sending the rendered second portion of the content in the requested output format to the device for display.

In certain aspects of the method, the rendering in the requested output format the second portion of the content includes searching a memory for a copy of the requested output format of the second portion of the content rendered in response to a previous request, and retrieving the requested output format the second portion of the content when found in the memory.

According to some implementations of the present disclosure, a system is provided. The system includes a memory that includes instructions, and a processor. The processor is configured to execute the instructions to receive a request on a device by an application to load a document that includes content for display by the application on the device, and render by the device at least a first portion of the content for display. The processor is further configured to execute the instructions to assign rendering of the first portion of the content to a first process of the application, and rendering of a second portion of the content to a second process of the application, and send a request by the second process to a remote device to render at least the second portion of the content for display. The processor is further configured to execute the instructions to receive from the remote device the rendered second portion of the content, and composite the rendered first portion of the content and the rendered second portion of the content for display by the application on the device.

In certain aspects of the system, the request sent to the remote device includes information regarding the device that is usable by the remote device to determine at least an output format of the rendered second portion of the content. In certain aspects of the system, the information regarding the device includes information identifying resources available to the device, software operating on the device, and a requested output format for the rendered second portion of the content. In certain aspects of the system, the first portion of the content is provided by a first website, and the second portion of the content is provided by a second website. In certain aspects, the document includes a webpage, the application includes a web browser, and the second portion of the content is provided in an iframe within the webpage. In certain aspects, the second portion of the content includes an advertisement, and the decision to send the request to the remote device is made because at least one of the devices will take longer to render the advertisement than the remote device will take to render and provide the rendered advertisement to the device, the advertisement is not interactive, or the device is determined to have insufficient resources to commit to rendering of the advertisement. In certain aspects of the system, the second portion of the content includes a plurality of advertisements, the document includes a webpage, the application includes a web browser, and each of the plurality of advertisements is displayed in a respective iframe of the webpage, and wherein the processor is further configured to assign rendering of the first portion of the content to a first process of the application, and rendering of each of the plurality of the advertisements to additional processes of the application, wherein the sending the request and the receiving the rendered second portion of the content is conducted for each of the plurality of the advertisements by their respective additional processes.

According to some implementations of the present disclosure, a system is provided. The system includes a memory that includes instructions, and a processor. The processor is configured to execute the instructions to receive a request at a server from an application on a device requesting rendering of a second portion of content of a document for display, the document that includes a first portion of content and the second portion of content, and the request that includes information identifying resources available to the device, software operating on the device, and a requested output format for the rendered second portion of the content, and search the memory for a copy of the requested output format of the second portion of the content rendered in response to a previous request. When the requested output format of the second portion of the content is found in the memory, the processor is configured to retrieve the requested output format for the second portion of the content when found in the memory, and when the requested output format of the second portion of the content is not found in the memory, the processor is configured to have the server render, in the requested output format the second portion of the content for display. The processor is configured to send the rendered second portion of the content in the requested output format to the device for display.

According to some implementations of the present disclosure, a machine-readable storage medium that includes machine-readable instructions for causing a processor to execute a method is provided. The method includes receiving a request on a device by an application to load a webpage that includes content for display by the application on the device, the webpage that includes a plurality of advertisements in respective frames, and assigning rendering of the first portion of the content to a first process of the application. The method also includes rendering by the device at least a first portion of the content for display, and assigning rendering of each of the plurality of the advertisements to additional processes of the application. The method also includes sending, by each of the respective additional processes, a request to a remote device to render for display the advertisement assigned to the respective additional process, and receiving from the remote device by each of the respective additional processes the rendered plurality of advertisements. The method also includes compositing the rendered first portion of the content and the rendered plurality of advertisements for display in the webpage by the application on the device.

According to some implementations of the present disclosure, a machine-readable storage medium that includes machine-readable instructions for causing a processor to execute a method is provided. The method includes receiving a request at a server from an application on a device requesting rendering of a second portion of content of a document for display, the document that includes a first portion of content and the second portion of content, and the request that includes information identifying resources available to the device, software operating on the device, and a requested output format for the rendered second portion of the content, and searching the memory for a copy of the requested output format of the second portion of the content rendered in response to a previous request. The method also includes retrieving the requested output format of the second portion of the content when the requested output format of the second portion of the content is found in the memory, and rendering by the server in the requested output format the second portion of the content for display. The method further includes sending the rendered second portion of the content in the requested output format to the device for display.

According to some implementations of the present disclosure, a system is provided. The system includes means for receiving a request on a device by an application to load a document that includes content for display by the application on the device, and means for rendering by the device at least a first portion of the content for display. The system also includes means for sending a request to a remote device to render at least a second portion of the content for display, and receiving from the remote device the rendered second portion of the content, and the means for rendering is further configured to composite the rendered first portion of the content and the rendered second portion of the content for display by the application on the device.

In certain aspects of the system, the means for rendering is further configured to assign rendering of the first portion of the content to a first process of the application, and rendering of the second portion of the content to a second process of the application, wherein the sending the request and the receiving the rendered second portion of the content is conducted by the second process. In certain aspects of the system, the request sent to the remote device includes information regarding the device that is usable by the remote device to determine at least an output format of the rendered second portion of the content. In certain aspects, the information regarding the device includes information identifying resources available to the device, software operating on the device, and a requested output format for the rendered second portion of the content. In certain aspects of the system, the first portion of the content is provided by a first website, and the second portion of the content is provided by a second website. In certain aspects, the document includes a webpage, the application includes a web browser, and the second portion of the content is provided in an iframe within the webpage. In certain aspects, the second portion of the content includes an advertisement, and the decision to send the request to the remote device is made because at least one of the device will take longer to render the advertisement than the remote device will take to render and provide the rendered advertisement to the device, the advertisement is not interactive, or the device is determined to have insufficient resources to commit to rendering of the advertisement. In certain aspects of the system, the second portion of the content includes a plurality of advertisements, the document includes a webpage, the application includes a web browser, and each of the plurality of advertisements is displayed in a respective iframe of the webpage, and the means for rendering is further configured to assign rendering of the first portion of the content to a first process of the application, and rendering of each of the plurality of the advertisements to additional processes of the application, wherein the sending the request and the receiving the rendered second portion of the content is conducted for each of the plurality of the advertisements by their respective additional processes.

According to some implementations of the present disclosure, a system is provided. The system includes means for receiving a request at a server from an application on a device requesting rendering of a second portion of content of a document for display, the document that includes a first portion of content and the second portion of content, and the request that includes information identifying resources available to the device, software operating on the device, and a requested output format for the rendered second portion of the content. The system also includes means for rendering by the server in the requested output format the second portion of the content for display based on the resources available to the device and software operating on the device, and means for sending the rendered second portion of the content in the requested output format to the device for display.

In certain aspects of the system, the rendering in the requested output format of the second portion of the content includes searching a memory for a previously-rendered output in the requested output format of the second portion of the content, and retrieving the requested output for the second portion of the content when found in the memory.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed implementations and together with the description serve to explain the principles of the disclosed implementations. In the drawings:

FIG. 1 illustrates an example architecture for compositing content for display on a client that has been requested for display on the client and at least partially rendered with the assistance of a server.

FIG. 2 is a block diagram illustrating an example client and server from the architecture of FIG. 1 according to certain aspects of the disclosure.

FIG. 3 illustrates an example process for compositing content for display on a client that has been requested for display on the client and at least partially rendered with the assistance of a server using an example client and server of FIG. 2.

FIGS. 4A and 4B are example illustrations associated with the example process of FIG. 3.

FIG. 5 is a block diagram illustrating an example computer system with which the client and server of FIG. 2 can be implemented.

### DETAILED DESCRIPTION

In the following detailed description, numerous specific details are set forth to provide a full understanding of the present disclosure. It will be apparent, however, that the implementations of the present disclosure may be practiced without some of these specific details. In other instances, well-known structures and techniques have not been shown in detail so as not to obscure the disclosure.

The disclosed system provides for the remote rendering of certain portions (e.g., visual layers) of a document, such as a web page, to be displayed in an application while other portions of the web page are rendered locally, and then the different portions are combined and displayed to the user using a compositor of the application. As discussed herein, the document can be apportioned to different graphical layers. In situations where a web page includes various different content for display, such as in different frames (e.g., inline frames or “iframes”), rendering and display of the web page can be delayed by its computational cost if done entirely on the device displaying the web page. This is particularly the case if the device has reduced resources, such as with mobile devices, and if the web page includes iframes of advertisements, which tend to be resource intensive. As a result, such advertisements may slow down the rendering and display of web pages by consuming a significant amount of the device's processing capacity and network bandwidth, and correspondingly reduce the device's battery life. Thus, rendering such advertisements by a mobile device can negatively impact battery life and network speed.

The disclosed system addresses this technical problem tied to computer technology and arising in the realm of computer networks, namely of delayed rendering and display of visual content of a downloaded web page due to limited local resources, by having the application on a device (“local device”) that request that a remote device, such as a server, render at least a portion of the web page, such as an advertisement in an iframe, and send the rendered portion of the web page back to the local device for display. This solution can be implemented by having at least one process of the application be responsible for local rendering of visual content for the web page, and another process of the application be responsible for requesting the remote rendering of other visual content for the web page and receiving the other visual content from the remote device after it is rendered. Thereafter the compositor for the application can composite both the locally rendered visual content and the remotely rendered visual content for display in the application. This solution is rooted in computer technology by, for example, an optimization of computer resource usage and a division of computer processes, and results in the web page requested for display being displayed more quickly by the application on the local device. The solution further permits the local device to use less memory and processing capacity, and results in faster display time of the web page. The application can further optimize the rendering and display process by providing additional information to the remote device responsible for the remote rendering, including what resources and software are available to the local device, and in what format the remotely rendered content should be provided back to the local device.

Implementation of the disclosed solution results in web pages with visual content loading for display more quickly because less content is being sent over the network to the local device. This occurs, for example, where visual content may include significant data (e.g., a large data file) prior to rendering, but little data (e.g., a small data file) after it is rendered. This advantageous result is particularly beneficial for bandwidth-constrained devices and bandwidth-constrained geographical regions. Implementation of the disclosed solution also results in longer battery life for mobile devices as at least some of the rendering work for visual content is done remotely and not by the processor of the mobile device. Implementation of the disclosed solution further results in more responsive visual content as fewer processor clock cycles are spent by the local device by having the remote device conduct at least some of the processing for rendering. Implementation of the disclosed solution also facilitates more efficient use of processing capacity in the cloud, as the same visual content rendered by a remote device need only be rendered once and then delivered to multiple local devices. Implementation of the disclosed solution further results in appropriate prioritization of content for display, as lower priority visual content can be sent to the remote device for rendering and if the visual content is not returned in an appropriate timeframe, the visual content need not be displayed as part of the web page without significantly negatively impacting a user's web browsing experience.

Where the visual content rendered remotely is an advertisement, implementation of the disclosed solution also results in the remote device identifying which pixels from the advertisement are displayed to the user, thus allowing the advertiser or advertisement system to better identify what the user saw from the advertisement. Implementation also results in information about the user's device being partitioned in a way that is likely to satisfy a user's desire for privacy, as the advertisement is less likely to be able to identify aspects of the user's device or application because the advertisement is rendered remotely (e.g., on a server) and the client can completely control which information about the user is shared with the remote device. Additionally, as advertisement formats commonly evolve more rapidly than other visual web content, the process for rendering such rapidly evolving advertisements can evolve with the push rate of server side software and hardware and need not be limited the rate of change of web standards associated with applications on a user's local device.

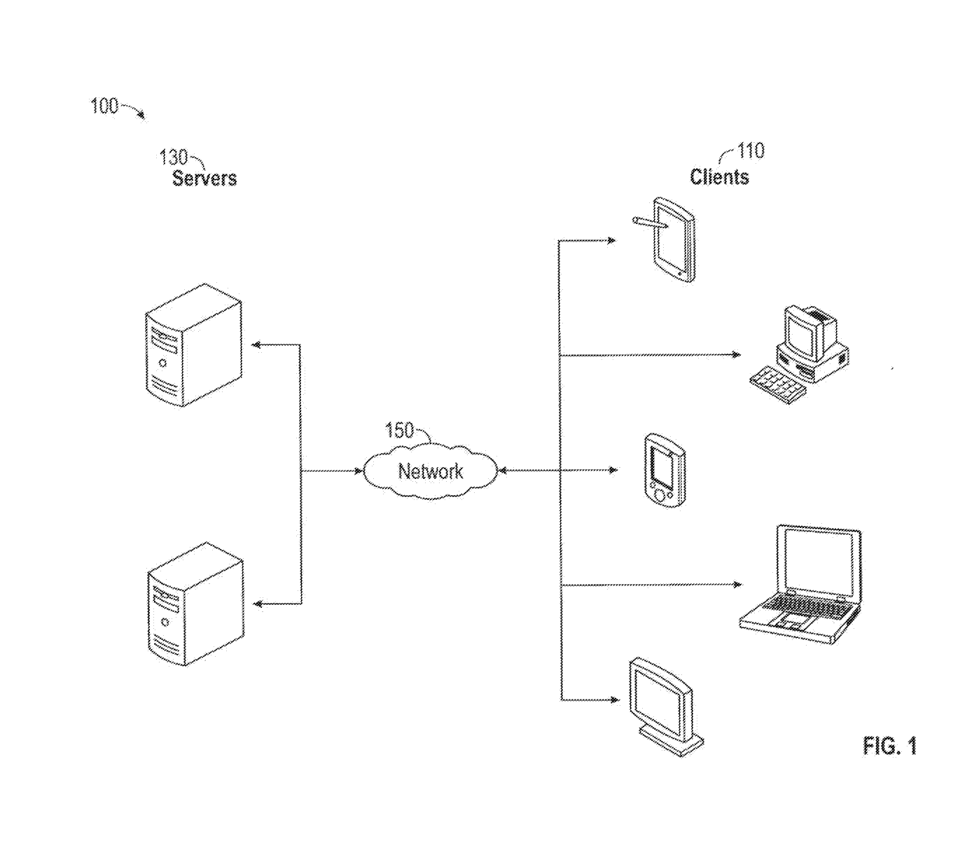

FIG. 1 illustrates an example architecture 100 for compositing content for display on a client that has been requested for display on the client and at least partially rendered with the assistance of a server. The architecture 100 includes servers 130 and clients 110 connected over a network 150.

Each of the clients 110 is configured to download, install, and run an application, such as a web browser, incorporating features as disclosed herein. The application is configured to run on clients 110 that are mobile or non-mobile. The clients 110 can be, for example, desktop computers, laptop computers, mobile devices (e.g., a smartphone, tablet computer, or personal digital assistant (PDA)), set top boxes (e.g., for a television), video game consoles, or any other devices having appropriate processor, memory, and communications capabilities. In certain aspects, certain advantages of the application, such as faster display of content and preservation of processing and battery resources, are more salient on clients 110 that are mobile devices (e.g., tablet computers or smartphones).

The application, once installed on a client 110, is configured to load web pages from any one or multiple servers 130 hosting the web pages. The servers 130 can be any device having an appropriate processor, memory, and communications capability for hosting the data for installing the web browser and for hosting the web pages. The network 150 can include, for example, any one or more of a local area network (LAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

The disclosed application, once downloaded from a server 130 and installed and executed on a client 110, is configured to display content. The content can be, for example, web pages, images, video, documents, or any other visible content that is rendered for display. The disclosed application includes a compositor. The compositor is configured to composite rendered content for display. The disclosed application is configured to receive a request to load a document for display on a client 110, and then determine whether a portion of the document that is to be displayed should be rendered remotely by a server 130, or whether the entire document should be rendered locally. The determination is based on factors such as resources available to the client 110, the importance of the content to be rendered, and the speed at which the server 130 is expected to render the content. The application assigns different processes the responsibility of rendering portions of the document, and if the application determines that a portion of the document should be rendered remotely, the corresponding process sends information on that portion of the document to a server 130 and requests that the server 130 return a rendered version of that portion of the document. Thereafter, when the processes of the application assigned with rendering portions of the document locally have completed rendering, and the processes of the application assigned with having portions of the document rendered remotely have obtained copies of the remotely rendered portions of content, then the rendered portions of content are provided to the compositor for compositing and display by the application on the client 110.

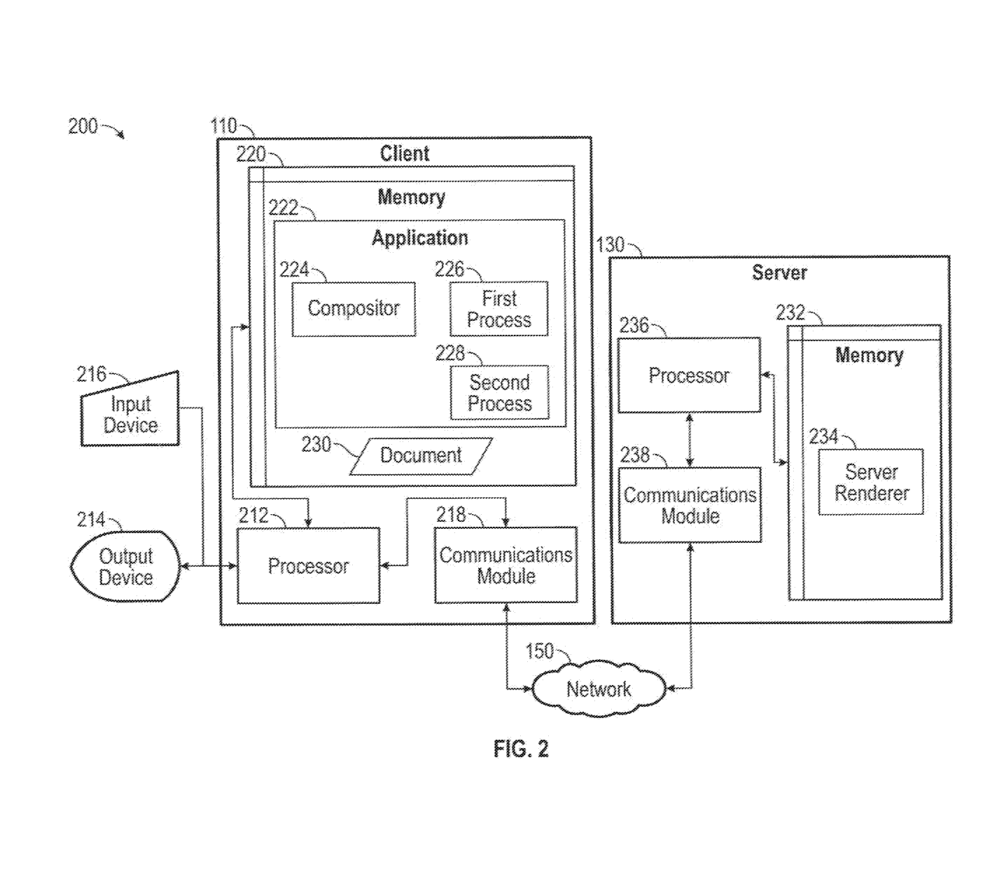

FIG. 2 is a block diagram 200 illustrating an example server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The client 110 includes a processor 212, the communications module 218, and a memory 220. The client also includes an input device 216, such as a keyboard, touchscreen, and/or mouse, and an output device 214, such as a display. In certain aspects, the input device 216 and output device 214 can be combined in a single hardware device, such as a touchscreen display.

The memory 220 of the client 110 includes an application 222 and a document 230 to be displayed by the application 222. The application 222 can be, for example, a web browser, document viewer, document editor, or other application configured to display rendered content. The document 230 can be, for example, a web page that includes (e.g., references, for example, by way of web address) content provided by different websites (e.g., content hosted on different servers 13). The web page can include inline frames (“iframes”) and advertisements. In certain aspects, each iframe in the document 230 can include (e.g., by way of reference to) a corresponding advertisement. The non-advertisement content and the advertisements for the document 230 can be hosted or generated dynamically by different servers 130. In certain aspects not illustrated, the memory 220 is understood to include an operating system, a supervisor process, and a compositor process in addition to the first process 226 and the second process 228. In such aspects, the document 230 passes through the supervisor process and is divided into portions that reside in the memory 220 that are then assigned to the first process 226 and second process 228.

The application 222 includes a compositor 224, a first process 226, and a second process 228 (also referred to as a “server-proxy process”). The processor 212 of the client 110 is configured to execute instructions, such as instructions physically coded into the processor 212, instructions received from software in memory 240, or a combination of both. For example, the processor 212 of the client 110 executes instructions from the application 222 to receive a request on the client 110 by the application 222 to load the document 230 that includes content for display by the application 222 using the output device 214 of the client 110. The request can be received, for example, from a user using the input device 216 to input a uniform resource locator of a document (e.g., a webpage) to be retrieved over the network 150 using the communications module 218 of the client 110 and loaded for display on the output device 214 of the client 110.

Where the document 230 includes various portions of content for display, the application 222 can assign rendering of a first portion of the content of the document 230 to a first process 226 of the application 222, and assign rendering of a second portion of the content of the document 230 to a second process 228 of the application 222.

The processor 212 is also configured to render, using the processor 212 of the client 110, at least a first portion of the content of the document 230 for display. As noted above, this may be carried out by the first process 226 of the application 222. The processor 212 is further configured to send, over the network 150 using communications module 218, a request to a remote device, the server 130, to render at least a second portion of the content of the document 230 for display, and receive the rendered second portion of the content back from the server 130. As noted above, the second process 228 of the application 222 may carry out these steps. In certain aspects, the request sent to the server 130 can include references to the second portion of the content of the document 230 as opposed to the second portion of the content itself.

Where various portions of the content of the document 230 include multiple advertisements, the application 222 can assign rendering of the first portion of the content to a first process of the application, and rendering of each of the plurality of the advertisements to additional processes of the application (not illustrated). The sending of the request and the receiving of the rendered second portion of the content can be conducted for each of the plurality of the advertisements by their respective additional processes.

In certain aspects, the request sent to the server 130 can include information regarding the client 110 that is usable by the server 130 to determine at least an output format of the rendered second portion of the content of the document 230. The information can be, for example, an identification of resources available to the client 110. The resources can include both total and available values of processing capacity, memory capacity, storage capacity, battery capacity, and network speed. The information can also indicate, for example, software operating on the client 110, such as a type and version information for an operating system of the client 110, the application 222, and codecs available to the client 110. The information can also include a requested output format for the rendered second portion of the content of the document 230 to be provided to the application 222 for rendering. The information can also include an indication to the server 130 to store any cookies or other tracking information associated with the second portion of the content on the server 130, or to provide any such cookies or tracking information back with the rendered second portion of the content.

In certain aspects where the document 230 is a webpage, the application 222 is a web browser, and the second portion of the content of the document 230 is an iframe within the webpage that contains an advertisement, a decision to send the request to the server 130 to have the server 130 render the second portion of the content of the document 230 instead of having the processor 212 of the client 110 render second portion of the content of the document 230 is made because the client 110 is estimated to take longer to render the advertisement than the server 130 will take to render and provide the rendered advertisement back to the client 110. This estimation of rendering times take into account, for example, total and available values of processing capacity, memory capacity, storage capacity, and network speed of the client 110. The decision can also be made to send the request to the server 130 to have the server 130 render the second portion of the content of the document 230 instead of the client 110 because the advertisement is not interactive, and therefore will not need to be rendered locally and continuously by the client 110 in response to a user's interaction with the advertisement, or because the client 110 is determined to have insufficient resources to commit to rendering of the advertisement, the resources including processing capacity, memory capacity, storage capacity, battery capacity, or network speed. In certain aspects, the decision to send the request to the server 130 to have the server 130 render the second portion of the content of the document 230 is made when the client 110 is a mobile device, but when the client 110 is a non-mobile device, the processor 212 of the client 110 renders the second portion of the content of the document 230.

The server 130 includes a processor 236, a communications module 238, and a memory 232 that includes a server renderer 234 responsible for instructing the processor 236 of the server 130 to render content. The processor 236 of the server 130 is configured to execute instructions, such as instructions physically coded into the processor 236, instructions received from software in memory 240, or a combination of both. For example, the processor 236 of the server 130 executes instructions to receive a request from the application 222 on the client 110 over the network 150 (e.g., using the communications module 238 of the server 130) requesting rendering of the second portion of content of the document 230 for display. The request may also include the information noted above identifying resources available to the client 110, software operating on the client 110, and a requested output format for the rendered second portion of the document 230.

The processor 236 of the server 130 is further configured to render in the requested output format the second portion of the content of the document 230 for display taking into account the information provided on the resources available to the client 110 and software operating on the client 110. For example, if the second portion of the content of the document 230 includes a video advertisement, and the information provided by the client 110 indicates the client has limited processing and memory capacity available to display a video advertisement along with the rest of the content of the document 230, then the server renderer 234 may render the video advertisement in an output format that includes a series of still images instead of a video format. The output format of a series of still images may have been requested by the client 110, but in instances where the client 110 provides a general category of requested output formats or a range of requested output formats to the server 130, the server 130 may determine, based on the resources available to the client 110 and software operating on the client 110, in which output format to render the second portion of the content of the document 230.

In certain aspects, the processor 236 of the server 130 is configured to search the memory 232 of the server 130, or alternatively another remote memory available to the server 130, for a copy of the requested output format of the second portion of the content of the document 230 so that the server 130 does not need to use processing capacity of its processor 236 to render the second portion of content. The copy of the requested output format of the second portion of the content may have been previously rendered by the server 130 or another server in response to a previous request to render the second portion of the content (e.g., from a different client), and thereafter stored in memory for later reuse. If a copy of the requested output format of the second portion of the content is found in a memory, then the processor 236 is configured to retrieve the requested output format the second portion of the content when found in the memory. This feature facilitates more efficient use of processing capacity among servers 130 as the same visual content rendered by a server 130 need only be rendered once and can then be delivered to multiple clients 110. After the second portion of the content of the document 230 is rendered in the requested output format, the processor 236 of the server 130 is configured to send the rendered second portion of the content to the client 110 for display.

The processor 212 of the client 110 is configured to receive from the server 130 over the network 150 the rendered second portion of the content of the document 230, and composite, using the compositor 224 of the application 222, the rendered first portion of the content and the rendered second portion of the content for display by the application 222 using the output device 214 of the client 110. A user may then view the document 230 as displayed by the output device 214 of the client 110 and interact with the document 230 using the input device 216 of the client 110.

In certain aspects where the rendered second portion of content of the document is not received in a timely manner from the server 130, but the rendered first portion of content is available, and the second portion of content is determined not to be important enough to delay display of the document 230 (e.g., where the second portion of content is an advertisement), then the compositor 224 may proceed with compositing the document 230 without the rendered second portion of content, and the application 222 may proceed with displaying the document 230. This results in appropriate prioritization of content for display and enhances a user's experience of the content by removing delay of displayed document 230 due to low priority portions of content in the document 230.

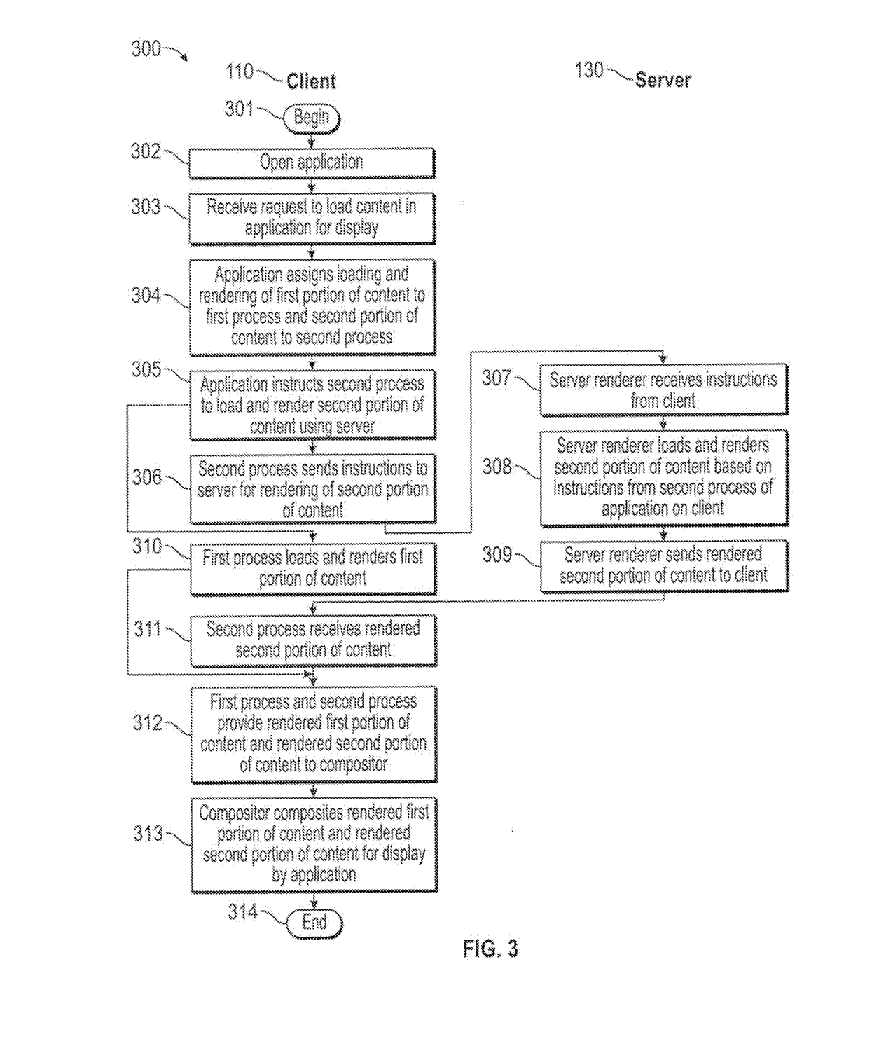

FIG. 3 illustrates an example process 300 for compositing content for display on the client 110 that has been requested for display on the client 110 and at least partially rendered with the assistance of the server 130 using the client 110 and server 130 of FIG. 2. While FIG. 3 is described with reference to FIG. 2, it should be noted that the process steps of FIG. 3 may be performed by other systems.

The process 300 begins with the client 110 by proceeding from beginning step 301 to step 302 when an application 222 is opened on the client 110. In step 303 the application 222 receives a request to load a document 230 for display. In step 304, the application 222 assigns loading and rendering of a first portion of content of the document 230 to the first process 226 of the application 222 and assigns loading and rendering of a second portion of content of the document 230 to the second process 228 of the application 222

Next, in step 305, the application 222 instructs the second process 228 to have the server 130 load and render the second portion of content of the document 230. In parallel with or subsequent to step 305, the first process 226 of the application 222 loads and renders the first portion of content of the document 230. In step 306 the second process 228 sends instructions to the server 130 for loading and rendering of the second portion of content of the document 230.

Turning to the server 130, the server renderer 234 in step 307 receives the instructions of step 305 from the client 110, and in step 308 the server renderer 234 loads and renders the second portion of content based on the instructions from the second process 228 of the application 222 on the client 110. In step 309 the server renderer 234 sends the rendered second portion of content to the client 110.

Returning to the client 110, in step 311 the second process 228 of the application 222 on the client 110 receives the rendered second portion of content of the document 230 from the server 130. In step 312, the first process 226 and the second process 228 provide the rendered first portion of content and the rendered second portion of content to the compositor 224 of the application 222, and in step 313 the compositor 224 composites the rendered first portion of content and the rendered second portion of content of the document 230 for display by the application 222. The process 300 then ends in step 314.

FIG. 3 set forth an example process 300 for compositing content for display on the client 110 that has been requested for display on the client 110 and at least partially rendered with the assistance of the server 130 using the client 110 and server 130 of FIG. 2. An example will now be described using the example process 300 of FIG. 3, an application 222 that is a web browser, a document 230 that is a web page, a first portion of content in the web page that is non-advertisement content, and a second portion of content in the web page that is an advertisement displayed in an iframe.

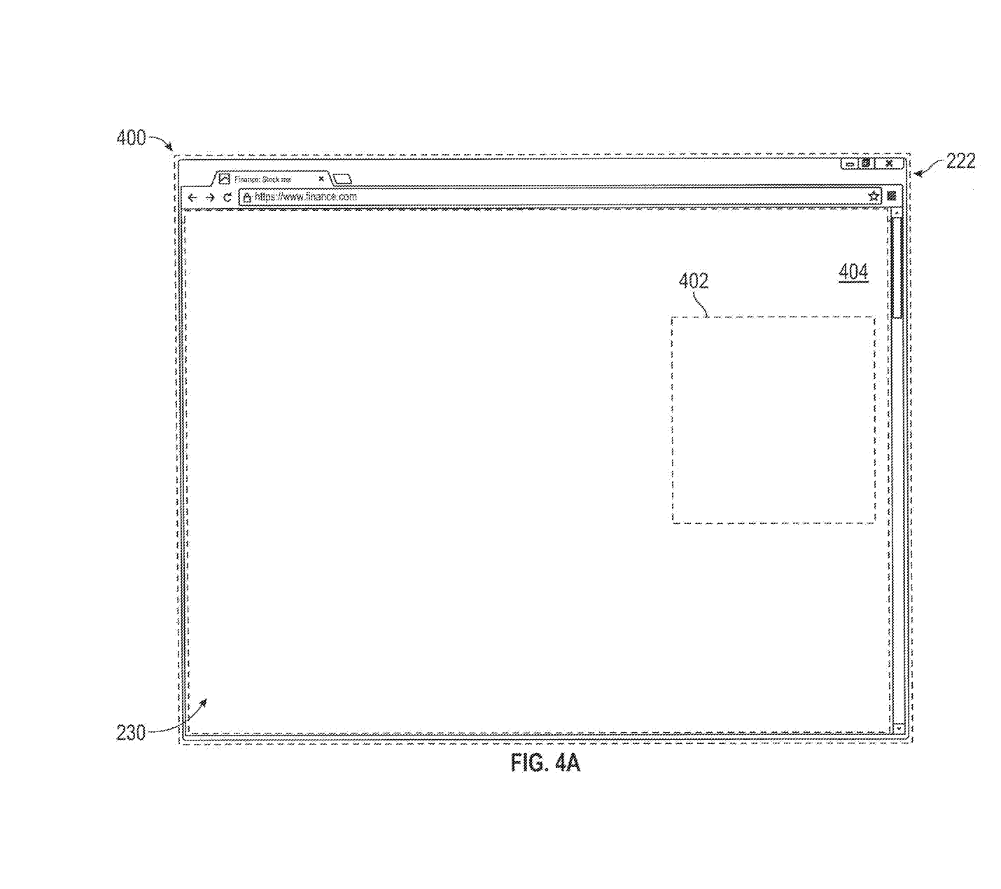

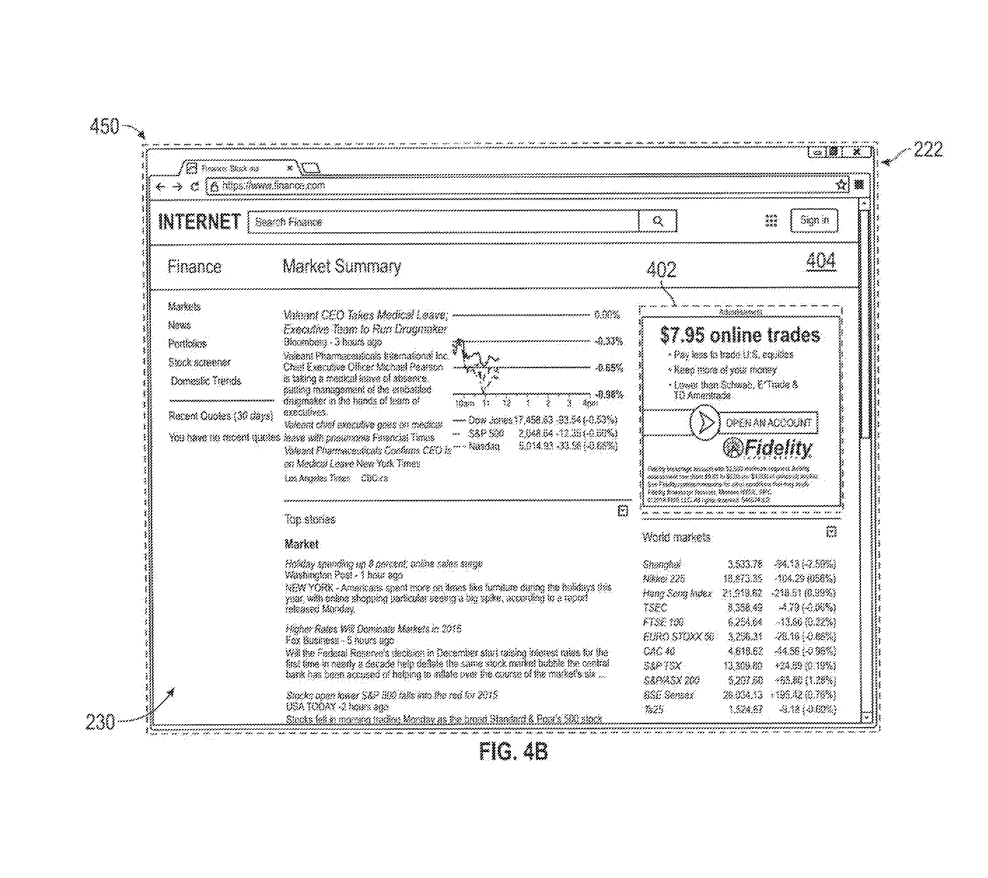

The process 300 begins with the client 110 by proceeding from beginning step 301 to step 302 when a user opens a web browser application 222 on the client 110. In step 303 the web browser application 222 receives a request from a user to load a web page document 230 located at www.finances.cm for display because the user entered the uniform resource locator “www.finances.cm” in the web browser application 222, and the web browser application 222 begins to retrieve the web page document 230 located at “www.finances.cm” over the network 150. An example screenshot 400 of the web browser application 222 on the client 110 retrieving the web page document 230 is shown in FIG. 4A.

In step 304, the web browser application 222 processes the web page document 230 as it is received and determines that the web page document 230 includes non-advertisement content hosted on a server, and advertisement content hosted on another server and located in an iframe of the web page document 230, and assigns loading and rendering of a first portion of content 404 of the web page document 230, namely non-advertisement content hosted on a server, to the first process 226 of the web browser application 222 and assigns loading and rendering of a second portion of content of the document 230, namely an advertisement hosted on another server displayed in an iframe 402 to the second process 228 of the web browser application 222. Specifically, the advertisement is a video for an investment website that includes a three-dimensional model of an object that can be interacted with.

Next, in step 305, the web browser application 222 instructs the second process 228 to load and render the advertisement in the iframe 402 using a server renderer 234 on the server 130 because the advertisement could not be rendered quickly on the client 110, but could be rendered quickly by the server 130 and heavily compressed when returned to the client 110 in order to save network bandwidth. In parallel with step 305 in step 310 the first process 226 of the web browser application 222 loads and renders the non-advertisement content of the web page document 230 by retrieving the non-advertisement content from the server on which it is hosted. In step 306 the second process 228 sends instructions to the server 130 for rendering of the advertisement. The instructions include information indicating to the server 130 that the server 130 should return the advertisement in a heavily compressed rendered video format. The instructions also include the version of the web browser application 222, information on the type of client 110, and graphics hardware of the client 110.

Turning to the server 130, the server renderer 234 in step 307 receives the instructions of step 305 from the client 110, and in step 308 the server renderer 234 loads and renders the advertisement of the web page document 230 based on the instructions from the second process 228 of the application 222 on the client 110. In step 309 the server renderer 234 sends the rendered advertisement to the client 110.

Returning to the client 110, in step 311 the second process 228 of the web browser application 222 on the client 110 receives the rendered advertisement of the document 230 from the server 130. In step 312, the first process 226 and the second process 228 provide the rendered non-advertisement content and rendered advertisement content of the web page document 230 to the compositor 224 of the web browser application 222, and in step 313 the compositor 224 composites the rendered non-advertisement content and rendered advertisement content of the web page document 230 for display to the user by the web browser application 222 using the output device 214. An example screenshot 450 of the rendered web page document 230 displayed in the web browser application 222 on the client 110 is shown in FIG. 4B. The process 300 then ends in step 314.

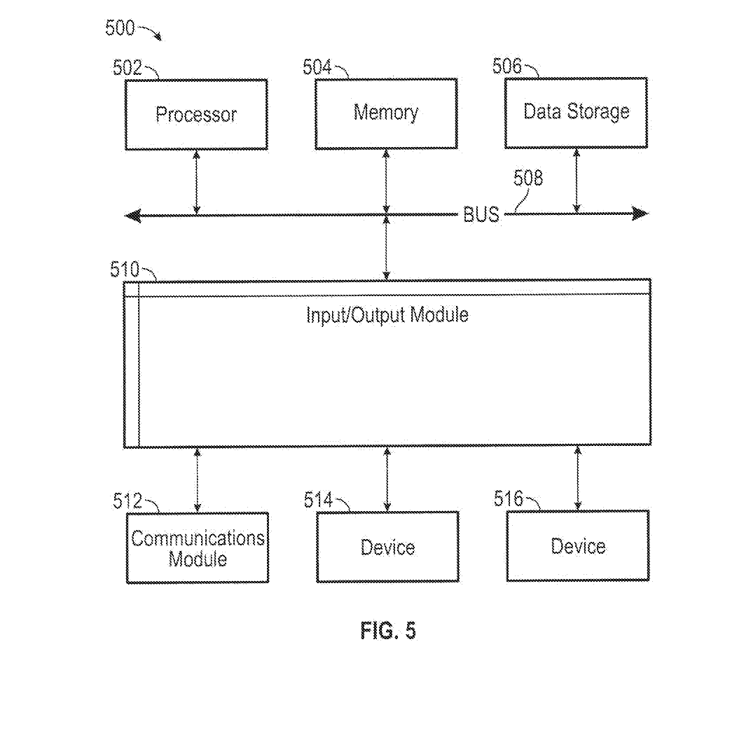

FIG. 5 is a block diagram illustrating an exemplary computer system 500 with which the client 110 and server 130 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client 110 and server 130) includes a bus 508 or other communication mechanism for communicating information, and a processor 502 (e.g., processor 212 and 236) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, with languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 (e.g., communications modules 218 and 238) include networking interface cards, such as Ethernet cards and modems. In certain aspects, the input/output module 510 is configured to connect to a plurality of devices, such as an input device 514 (e.g., input device 216) and/or an output device 516 (e.g., output device 214). Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 516 include display devices, such as a CRT (cathode ray tube) or LCD (liquid crystal display) monitor, for displaying information to the user.

According to one aspect of the present disclosure, the client 110 and server 130 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a LAN, a campus area network (CAN), a metropolitan area network (MAN), a WAN, a BBN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method comprising:
receiving a request on a device by an application to load a document comprising content for display on the device by the application;
rendering by the device at least a first portion of the content for display;
sending a request to a remote device to render at least a second portion of the content for display;
receiving from the remote device the rendered second portion of the content; and
compositing the rendered first portion of the content and the rendered second portion of the content for display by the application on the device.

2. The method of claim 1, further comprising:
assigning rendering of the first portion of the content to a first process of the application, and rendering of the second portion of the content to a second process of the application,
wherein the sending the request and the receiving the rendered second portion of the content is conducted by the second process.

3. The method of claim 1, wherein the request sent to the remote device comprises information regarding the device that is usable by the remote device to determine at least an output format of the rendered second portion of the content.

4. The method of claim 3, wherein the information regarding the device comprises information identifying resources available to the device, software operating on the device, and a requested output format for the rendered second portion of the content.

5. The method of claim 1, wherein the first portion of the content is provided by a first website, and the second portion of the content is provided by a second website.

6. The method of claim 5, wherein the document comprises a webpage, the application comprises a web browser, and the second portion of the content is provided in at least one iframe within the webpage.

7. The method of claim 6, wherein the second portion of the content comprises an advertisement, and wherein a decision to send the request to the remote device is made because at least one of the device will take longer to render the advertisement than the remote device will take to render and provide the rendered advertisement to the device, the advertisement is not interactive, or the device is determined to have insufficient resources to commit to rendering of the advertisement.

8. The method of claim 1, wherein the second portion of the content comprises a plurality of advertisements, the document comprises a webpage, the application comprises a web browser, and each of the plurality of advertisements is displayed in a respective iframe of the webpage, and the method further comprising:
assigning rendering of the first portion of the content to a first process of the application, and rendering of each of the plurality of the advertisements to additional processes of the application,
wherein the sending the request and the receiving the rendered second portion of the content is conducted for each of the plurality of the advertisements by their respective additional processes.

9. A system comprising:
a memory comprising instructions; and
a processor configured to execute the instructions to:
receive a request on a device by an application to load a document comprising content for display on the device by the application;
render by the device at least a first portion of the content for display;
assign rendering of the first portion of the content to a first process of the application, and rendering of a second portion of the content to a second process of the application;
send a request by the second process to a remote device to render at least the second portion of the content for display;
receive from the remote device the rendered second portion of the content; and
composite the rendered first portion of the content and the rendered second portion of the content for display by the application on the device.

10. The system of claim 9, wherein the request sent to the remote device comprises information regarding the device that is usable by the remote device to determine at least an output format of the rendered second portion of the content.

11. The system of claim 10, wherein the information regarding the device comprises information identifying resources available to the device, software operating on the device, and a requested output format for the rendered second portion of the content.

12. The system of claim 9, wherein the first portion of the content is provided by a first website, and the second portion of the content is provided by a second website.

13. The system of claim 12, wherein the document comprises a webpage, the application comprises a web browser, and the second portion of the content is provided in at least one iframe within the webpage.

14. The system of claim 13, wherein the second portion of the content comprises an advertisement, and wherein a decision to send the request to the remote device is made because at least one of the device will take longer to render the advertisement than the remote device will take to render and provide the rendered advertisement to the device, the advertisement is not interactive, or the device is determined to have insufficient resources to commit to rendering of the advertisement.

15. The system of claim 9, wherein the second portion of the content comprises a plurality of advertisements, the document comprises a webpage, the application comprises a web browser, and each of the plurality of advertisements is displayed in a respective iframe of the webpage, and wherein the processor is further configured to assign rendering of the first portion of the content to a first process of the application, and rendering of each of the plurality of the advertisements to additional processes of the application, wherein the processor being configured to send the request and receive the rendered second portion of the content is conducted for each of the plurality of the advertisements by their respective additional processes.

16. A machine-readable storage medium comprising machine-readable instructions for causing a processor to execute a method comprising:
receiving a request on a device by an application to load a webpage comprising content for display on the device by the application, the webpage comprising a plurality of advertisements in respective frames;
assigning rendering of a first portion of the content to a first process of the application;
rendering by the device at least a first portion of the content for display;
assigning rendering of each of the plurality of the advertisements to additional processes of the application;
sending, by each of the respective additional processes, a request to a remote device to render for display the advertisement assigned to the respective additional process;
receiving from the remote device by each of the respective additional processes the rendered plurality of advertisements; and
compositing the rendered first portion of the content and the rendered plurality of advertisements for display in the webpage by the application on the device.

17. The machine-readable storage medium of claim 16, wherein the request sent to the remote device comprises information regarding the device that is usable by the remote device to determine at least an output format of the rendered second portion of the content.

18. The machine-readable storage medium of claim 17, wherein the information regarding the device comprises information identifying resources available to the device, software operating on the device, and a requested output format for the rendered second portion of the content.

19. The machine-readable storage medium of claim 16, wherein the first portion of the content is provided by a first website, and the plurality of the advertisements is provided by at least a second website.

20. The machine-readable storage medium of claim 16, wherein a decision to send the requests to the remote device is made because at least one of the device will take longer to render the plurality of advertisements than the remote device will take to render and provide the rendered plurality of advertisements to the device, the plurality of advertisements are not interactive, or the device is determined to have insufficient resources to commit to rendering of the plurality of advertisements.
